(19) United States
(12) Patent Application Publication
(10) Pub. No.: US 2018/0005754 A1
(43) Pub. Date: Jan. 4, 2018

(54) Flux cancelling Rx coil for Wireless charging electronic device or smartphone or portable tablet or computer.

(71) Applicant: Prasad Joshi, Irvine, CA (US)

(72) Inventor: Prasad Joshi, Irvine, CA (US)

(21) Appl. No.: 15/089,590

(22) Filed: Apr. 4, 2016

(51) Int. Cl. H01F 38/14; H02J 7/02; H04B 5/00

(52) U.S. Cl. CPC H01F 38/14; H04B 5/0081; H02J 7/025; H04B 5/0037

(57) ABSTRACT

A system for wireless charging of an electronic device having a receiving coil, having: a charger having a transmit coil, wherein the transmit coil transmits a first flux having a first magnitude and a first direction, and wherein the receiving coil transmits a second flux having a second magnitude and a second direction, wherein the first magnitude is equal to the second magnitude, and the first direction is opposite of the second direction.

### CROSS-REFERENCE TO RELATED APPLICATIONS

None

### FEDERALLY SPONSORED RESEARCH

None

### SEQUENCE LISTING

None

### BACKGROUND OF INVENTION

In a wireless charging setup there is a transmit coil that is part of the charger. The transmit coil in the charger creates magnetic field based on the voltage and frequency impressed across the transmit coil. The flux and flux density is dependent on the Voltage across the coil, the frequency of the voltage wave, area of cross section of the center leg and the number of turns in the transmit coil. The Transmit coil can be planar in structure and the lines of flux will pass through the center of this planar coil. The power is transferred when another coil called as Receiving coil, Rx is placed within the flux field created by the transmit coil. The coupling between the two coils is through air. When the Rx coil comes within the field of the Tx coil it creates a current in the Rx coil based on the Ampere times Turns product. The Ampere turn product of the Rx coil is always equal to the Ampere turn product of the TX coil. This current in the Rx coil can be rectified and used to charge the battery in the receiving device. The Rx coil is typically placed on the bottom side of the electronic device or the smartphone or the portable computer or a computing tablet such as the iphone or the ipad or any other similar device. However, when the battery is charged and the receiving device is placed on the Charger mat that contains the Tx coil the magnetic field can interfere with the electronics on the receiving device. Since the device is already charged it does not need the power transfer to charge its own battery. However, the transmitting charger may still be transmitting power to other devices that may be in the vicinity and need to be charged. To shield the electronics in the receiving device or smartphone, Magnetic shields made from Ferrite are used between the Rx coil and the Printed Circuit board that contains the electronics for the charging device or smartphone or tablet. This magnetic shield is passive in nature and does provide a magnetic shield to the electronics. However, the effectiveness of this magnetic shield depends on the geometry of the shield and has to enclose the rest of the electronics to be truly effective. Also if the charging devices such as the smartphone or tablet is placed with the front side facing towards the Tx coil then this magnetic shield is not able to shield the electronics as the magnetic shield is no longer between the electronics of the charging device (such as smartphone or tablet). To accomplish this active shielding the proposed scheme creates a FLUX CANCEL mode if the device is already charged or needs to receive data from the cell tower and is not in the CHARGE mode and needs active shielding of its electronics from the magnetic field created by the Tx coil in the charger mat.

### BRIEF INVENTION SUMMARY

The proposed technique is to actively cancel the Flux that is transmitted by the charger from the Tx coil denoted as Øt in this document. This is done by the Rx coil which is actively energized in this FLUX CANCEL mode in such a way to create an equal amount of flux but in the opposite direction as that of the flux from the Tx coil.

### BRIEF DESCRIPTION OF THE DRAWINGS

FIG. 1: This figure shows how a Hall effect sensor works.

FIG. 2: This is the control loop block diagram for PWM type of Control scheme.

FIG. 3: This is the control diagram for a Pulse frequency modulation control scheme.

FIG. 4: This figure shows the flux cancellation due to the flux created by the Rx coil.

FIG. 5: This figure shows the flux cancellation due to the flux created by the Rx coil.

FIG. 6: This figure shows the Power stage of the proposed circuit that drives the Rx coil.

### DETAILED DESCRIPTION

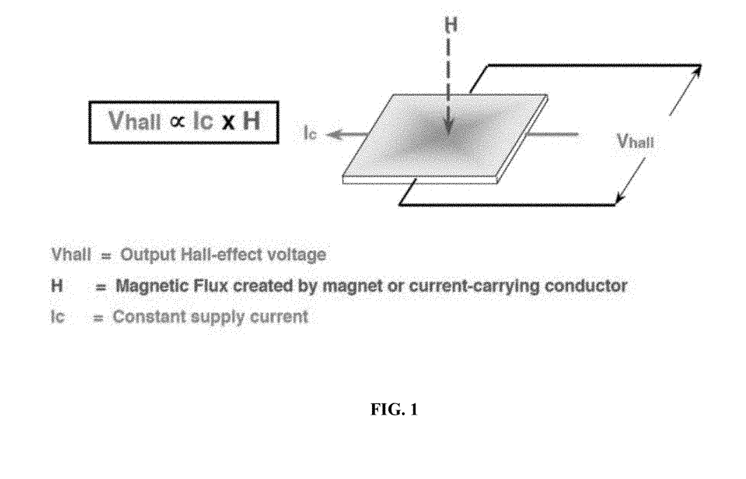

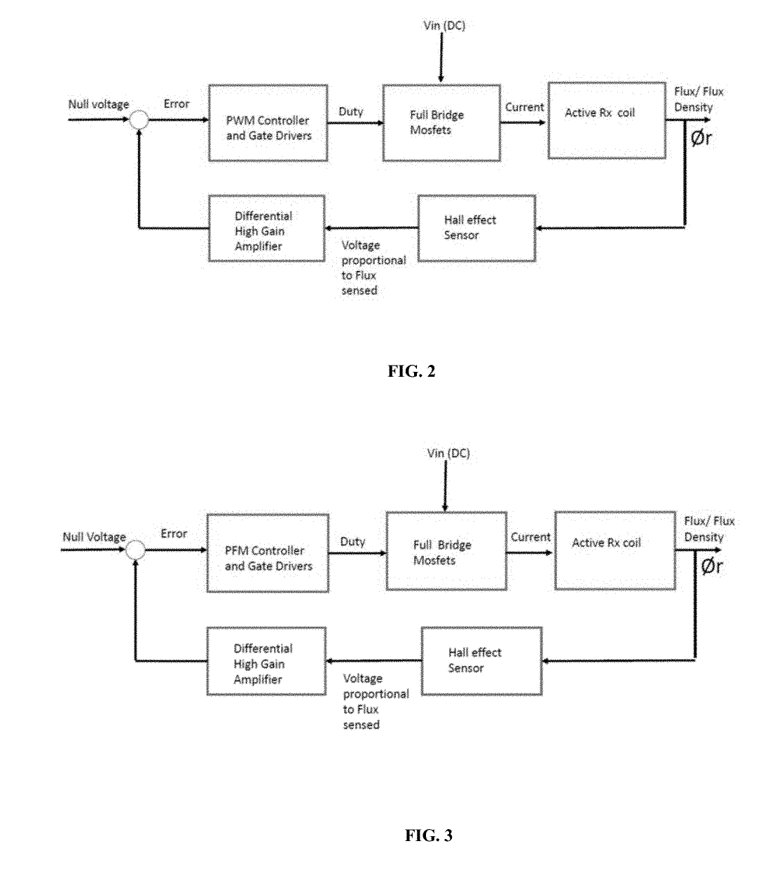

Operation: The proposed technique is to actively cancel the Flux that is transmitted by the Charger from the Tx coil denoted as Øt in this document. This is done by the Rx coil which is actively energized in this FLUX CANCEL mode in such a way to create an equal amount of flux but in the opposite direction as that of the flux from the Tx coil. This is accomplished by using a closed loop regulation control scheme as shown in FIG. 2 and FIG. 3. The magnitude and direction of the flux from the Tx coil is sensed using a ratio metric linear hall sensor. This sensor creates an output voltage that is proportional to the flux density of the magnetic field that is normal or perpendicular to the Hall sensor. This operation of the sensor is shown in FIG. 1. The output of this sensor is in in millivolts (2.5-3.75 mV per Gauss). This voltage is amplified by the differential amplifier so that the signal strength is sufficiently high enough and provides noise immunity. This signal from the Differential amplifier is compared with a zero-volt reference level by a high gain error amplifier. The reference level is 0 mV as the goal of the control loop is to create flux in the Rx coil that is of the same magnitude but opposite in polarity as that of the Tx coil and therefore will cancel the flux from the Tx. When the flux from the Rx coil (denoted as Ør in this document) is of opposite polarity as that of the Tx coil but equal in magnitude then the Net flux is zero as given by the expression below

Øt−Ør=0

Where Øt=Transmit flux and Ør=Receiver flux.

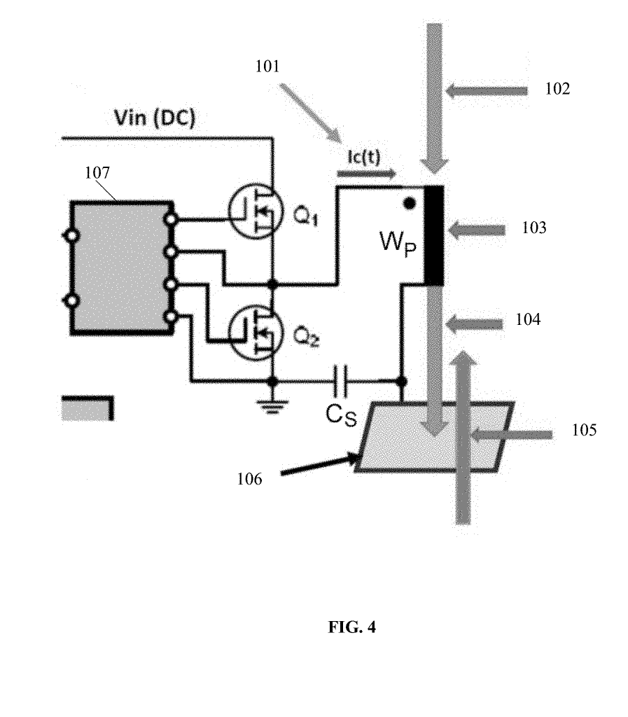

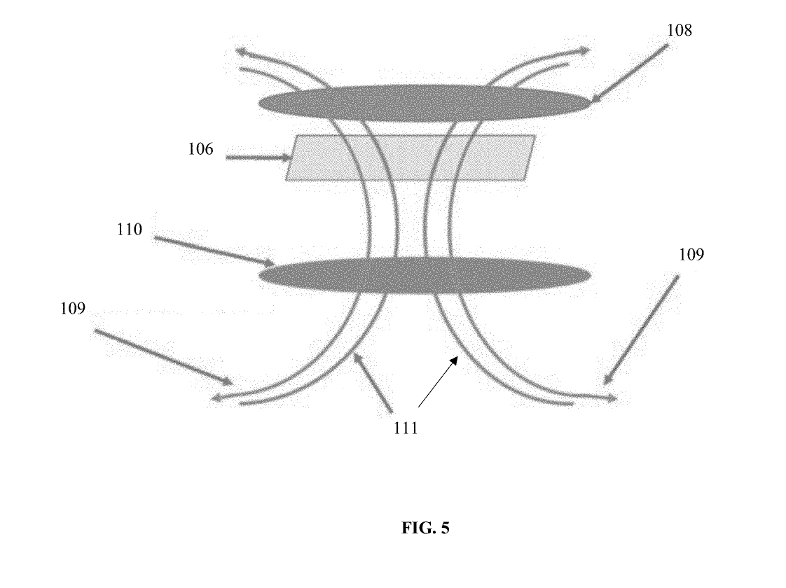

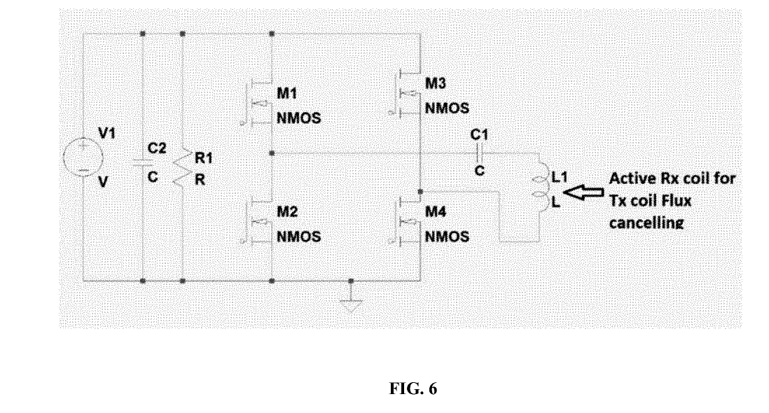

The high gain error amplifier that compares the Output of the differential amplifier has a PID Compensation scheme for optimum stability and transient response. The Output of the error amplifier is fed to either a PWM or a PFM controller that changes the pulse width in case of a PWM controller or changes the switching frequency in case of Pulse Frequency modulation scheme. This switching waveform is applied to the Full Bridge stage using High Current gain Isolated (High side/low side) Mosfet drivers of the switching square wave applied to the Full Bridge power stage. This Full Bridge power stage shown in FIG. 6 drives the Receive coil in such a way that the Flux Ør created by the Receive coil is of equal magnitude as that of the Tx coil but opposite in polarity or direction. The Hall effect sensor is located below the Rx coil. If the net flux passing through the Hall effect sensor from the Tx coil and the Rx coil is zero then the error in the regulation loop is minimized and a steady state condition is reached. Until then the loop keeps changing the duty or the switching frequency to change the magnitude and direction of the current in the Rx coil so that the flux Ør in the Rx coil is equal and opposite of the flux of the Tx coil, Øt. FIG. 4 and FIG. 5 illustrate this concept. Also when the Rx coil is not being driven by the Power stage Mosfet drivers in the Flux cancel mode, the Mosfets M1-M4 in FIG. 6 can be used to rectifiy the current that is created in the Rx coil during the CHARGE mode

FIG. 1: This figure shows how a Hall effect sensor works.

FIG. 2: This is the control loop block diagram for PWM type of Control scheme.

FIG. 3: This is the control diagram for a Pulse frequency modulation control scheme.

FIG. 4: This figure shows the flux cancellation due to the flux created by the Rx coil. Arrow 101 indicates current lc(t), where magnitude and direction is regulated to achieve zero net flux. Arrow 102 indicates flux of compensation coil based on direction and magnitude of lc(t). Arrow 103 indicates compensating active Rx coil with air core. Arrow 104 indicates flux of compensation coil, equaling flux of transmitting coil but opposite in direction to create zero net flux. Arrow 105 indicates flux of transmitting coil from a wireless charging pad. The Hall effect sensor is represented by 106. A driver module is represented by 107.

FIG. 5: This figure shows the flux cancellation due to the flux created by the Rx coil. Again, the Hall effect sensor is represented by 106. Plane 108 represents the active Rx coil. Plane 110 represents the Tx coil. Arrows 111 indicate the direction of the Tx coil flux. Arrows 109 indicate the direction of the Rx coil flux, which in null flux mode is equal in magnitude to and opposite in direction of the flux from the Tx coil.

FIG. 6: This figure shows the Power stage of the proposed circuit that drives the Rx coil. The figure illustrates the full bridge power stage driving the Active Rx coil when wireless power transfer is not required.

What is claimed is:

1. A system for wireless charging of an electronic device having a receiving coil, comprising: a charger having a transmit coil, wherein the transmit coil transmits a first flux having a first magnitude and a first direction, and wherein the receiving coil transmits a second flux having a second magnitude and a second direction, wherein the first magnitude is equal to the second magnitude, and the first direction is opposite of the second direction.

2. A method of adding a flux cancel mode to a receiver coil Rx of a wireless charging system, comprising the steps of:
sourcing or sinking a current through the receiver coil Rx, the current having a first magnitude and a first direction; and
creating a first amount of flux equal to a second amount of flux having a second direction created by a transmit coil Tx of a Wireless Power charging system, the second direction being opposite to the first direction.
